(19) United States
(12) Patent Application Publication
(10) Pub. No.: US 2010/0175385 A1
(43) Pub. Date: Jul. 15, 2010

(54) Method for Increasing Turndown Capability in an Electric Power Generation System

(76) Inventors: Adam D. Plant, Orlando, FL (US); Christopher R. Oliveri, Orlando, FL (US); Bruce H. Carpenter, Orlando, FL (US); Damien G. Teehan, St. Cloud, FL (US); David D. Elwood, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/685,185

(22) Filed: Jan. 11, 2010

Related U.S. Application Data
(60) Provisional application No. 61/143,905, filed on Jan. 12, 2009.

(51) Int. Cl. F02C 9/18; F02C 6/00

(52) U.S. Cl. 60/773; 290/52

(57) ABSTRACT

A method of operating an electric power generation system (2). In one embodiment, a combustion chamber receives a combination of pressurized air (14) flow output from a compressor (12) and fuel (20) for combustion therein. The system (2) is operated at a relatively high steady state level of power output and then power is turned down by extracting a portion (34) of the pressurized air (14) flow before entry into the combustor (16). The method may further include throttling of air (14) flowing through the compressor (12) with inlet guide vanes (15). Features of the reduction in power include maintaining a characteristic combustor (16) minimum flame temperature with a volumetric percentage of NOₓ or CO emissions not exceeding those corresponding to the relatively high steady state operation.

### RELATED APPLICATION

This application claims priority to provisional patent application U.S. 61/143,905 filed 12 Jan. 2009 which is incorporated herein by reference in the entirety.

### FIELD OF THE INVENTION

The present invention relates generally to power systems and, more particularly, to power generation systems of the type incorporating gas turbines. More specifically, the invention relates to systems and methods for improving the operation of power plants during periods of low power demand.

### BACKGROUND OF THE INVENTION

Gas turbines are used in a variety of power system configurations for power generation depending on the size, nature and variability of power demands. Simple cycle power plants utilizing a gas turbine and a generator offer relatively low life cycle costs, but relatively low efficiencies on the order of forty percent. Commonly, gas turbine designs provide outputs ranging from five to 50 megawatts and much larger turbine outputs range in the hundreds of megawatts.

In large, more complex systems used for electric power generation, the gas turbine is normally the main drive unit in a combined cycle power plant, where the exhaust heat from one or more gas turbines driving an electrical generator is used to make steam to power one or more steam turbines which are also coupled to drive an electrical generator. These combined cycle power plants can reach overall efficiencies on the order of 58 percent or higher.

Gas turbines are often rated in terms of efficiency under a set of standard operating conditions, referred to as ISO ratings. The standard conditions include an ambient temperature of 15 degrees C., a relative humidity of sixty percent and atmospheric pressure at sea level. Under these conditions the operating characteristics, including efficiency, are rated at a maximum load, referred to as base load operation at one hundred percent rated power output.

Optimal operation of electric power plants for peak efficiencies requires turning down power outputs during periods of low power demand or simply taking equipment off line. A benefit of continuously operating the plant components during periods of low demand is the ability to quickly return the system to higher output upon demand for an increase in power. Plant maintenance costs are also lower when the systems are run continuously instead of incurring more frequent start-ups and shut-downs. However, operation during periods of low power demand has several drawbacks. Minimizing fuel consumption by operating gas turbine units at lower power output levels results in lower operating efficiencies, even to the extent that the plant may operate at a loss.

Emissions such as NOₓ and CO typically increase on a volumetric basis as gas turbine power decreases. With strict regulation of NOₓ and CO emissions, environmental compliance has required that lower limits be placed on reduced power output levels. Thus it has been a challenge to suitably turn down gas turbine power while complying with exhaust emissions requirements. With emissions levels being a function of combustor flame temperature, the air flow from the gas turbine compressor may be throttled via inlet guide vanes to reduce the amount of power generated while sustaining a sufficiently high temperature of combustion to provide requisite low volumetric emissions levels. In the past, with this approach the achievable range of low power commercial operation has been quite limited. This is because the extent to which the inlet guide vanes can be used to throttle down the air flow while sustaining necessary flame temperatures is limited. For example, the output from constant speed compressors of the type used for power generation can only be constrained up to a point before the reduced mass flow causes structural or aerodynamic concerns. Another consideration which stems from the lower volumetric air flow rate is that elevated exhaust gas temperatures, which accompany reduced turbine pressure when the mass air flow is diminished, approach the material limitations of the turbine exhaust components and other components downstream from the turbine section.

Consequently, due to limitations in operating range of the inlet guide vanes, there has been a limited range of reduced output power relative to the maximum rated load while also avoiding unacceptably high emissions levels. For example, in the temperature range of 0 degrees C. to about 15.5 degrees C. (i.e., 32 to 60 degrees F.), it has only been possible to reduce power output by about 30 to 38 percent.

It will benefit both the electric power industry and the consumer if the range of low power output can be extended beyond that which is currently achievable with throttling of inlet guide vanes.

### BRIEF DESCRIPTION OF THE DRAWING

The invention is explained in the following description in view of the drawings wherein:

FIG. 1 illustrates a combined cycle power generation system according to an embodiment of the invention; and

FIG. 2 provides a graphical comparison of achievable low power output limits between a conventional gas turbine system and a system configured according to the invention.

Like reference numbers are used to denote like features throughout the figures.

### DETAILED DESCRIPTION OF THE INVENTION

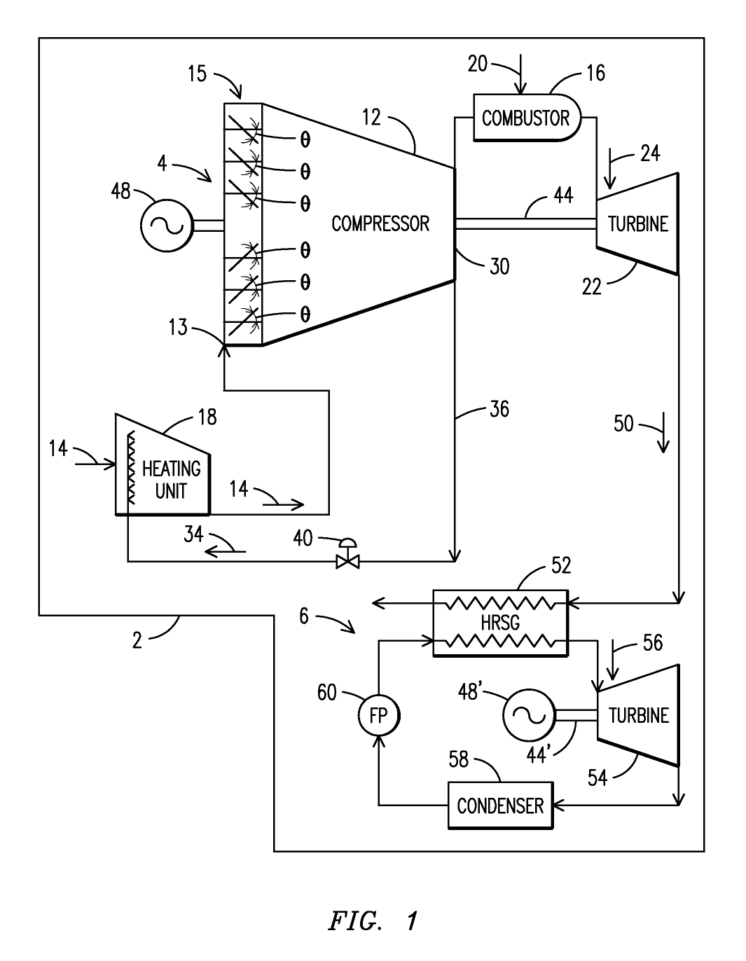

With reference to FIG. 1, there is shown in simplified schematic form a combined cycle electric power generation system 2 comprising a Brayton cycle 4 and a Rankine cycle 6. According to an embodiment of the invention, the Brayton cycle 4 includes a compressor 12 having an inlet port 13 which receives ambient air 14 that flows through a set of inlet guide vanes 15 for pressurization followed by discharge into a combustor 16. The air 14 is preheated by a heating unit 18 prior to intake by the compressor 12. Fuel 20 is also fed into the combustor 16 for reaction with the air 14. A set of adjustable inlet guide vanes 15 controls the amount of air flow entering the compressor 12. A power converting gas turbine 22 receives the hot gaseous exhaust gases 24 from the reaction of the air 14 and fuel 20 in the combustor 16. The hot exhaust gases 24 expand in the gas turbine 22 until they reach ambient pressure in a conventional manner.

An air extraction port 30 is located between the compressor 12 and the combustor 16 to remove a portion 34 of the compressed air which would otherwise be fed into the combustor 16. The portion 34 of compressed air is sent through a line 36 back to the heating unit 18 for mixing with the ambient air 14 upstream of the compressor inlet port 13, thus heating the air prior to entering the compressor 12. The proportion of compressed air recirculated through the compressor is selectable via a variable valve control 40. In the system 2 the compressor 12 is coupled via a common shaft 44 to both the turbine 22 and a first generator 48 to effect electric power generation.

Output 50 from the gas turbine 22, relatively low pressure, hot exhaust gases, is coupled to the Rankine cycle 6. The exhaust gases circulate through a Heat Recovery Steam Generator (HRSG) 52 for transfer of sensible heat to the Rankine cycle 6. The Rankine cycle 6, illustrated in part, further includes one or more steam turbines 54. The illustrated steam turbine 54 receives steam 56 from the HRSG 52 to transfer power via a shaft 44′ to a generator 48′. In other embodiments the Brayton cycle and the Rankine cycle may share a common shaft and generator unit. Steam exiting the turbine 54 is processed through a condenser 58 and returned to the HRSG via a feed water pump 60. Numerous other components commonly known to be included in the system 2 are not shown herein for simplicity of illustration.

With the exemplary arrangement according to the system 2, variable positioning of the inlet guide vanes 15 (indicated in the figure by a variable angle θ) partially reduces air intake to the compressor 12 in order to reduce power for part load operation. According to one embodiment of the invention, this power reduction is supplemented by extraction of the portion 34 of the compressed air to further reduce the gas turbine power while complying with emissions levels. By so extracting air from the compressor, e.g., from the compressor discharge, prior to entry into the combustor 16, a high fuel to air ratio is achieved in order to sustain the desired flame temperature, e.g., on the order of 1,450 degrees C.

For the embodiment of FIG. 1, the portion 34 of air 14 is extracted from the discharge of the compressor 12. Work is first performed on the extracted air, i.e., compression, but the turbine does not receive this portion 34 of hot gas which would otherwise be available to undergo expansion and thereby supplement production of power. Thus, there is an increase in compressor load relative to turbine power output. This results in a lower power output for a given flame temperature. Further, by heating the air 14 and by re-heating the portion 34 of the air which is recycled through the compressor, the density of air flowing into the combustor 16 is reduced, effectively reducing the mass flow of oxygen through the combustor 16 and turbine 22. This increases the available range of power turn down because both the turbine power output and fuel consumption are directly proportional to mass air flow.

The amount of air extracted from the compressor to effect the principles of the invention may vary considerably, but generally at least three percent of the mass volume should be recirculated and the proportion of extracted air to total output by the compressor can range up to ten percent or higher. Suitable operation can be effected by extracting and recirculating about 7 percent of the air produced by the compressor. The foregoing ranges are to be compared to relatively low levels, e.g., two percent or lower, of extracted compressor air used in deicing applications and having an insubstantial effect on power reduction.

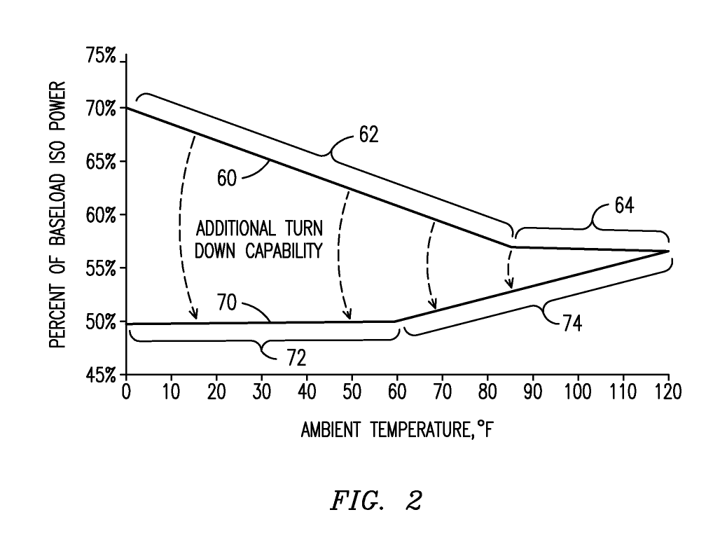

FIG. 2 illustrates a comparison of benefits for an example application of an embodiment of the method. The figure provides a comparison relative to prior art turn down capability using only inlet guide vanes to modulate the flow of air entering the compressor. In both cases a desired combustion flame temperature is maintained in order to sustain the same combustion exhaust temperature for proper emissions control. The figure illustrates achievable minimum power output levels as a function of ambient temperature, wherein the power is expressed as a percent of maximum load, i.e., base load ISO power. The data of FIG. 2 is presented for a Model SGT6-5000F gas turbine manufactured by Siemens Corporation. Similar advantages can be realized for other gas turbine systems.

The curves 60 and 70 of FIG. 2 each correspond to minimum power output levels along which NOₓ and CO emissions are in compliance. In this example, the NOₓ and CO levels could not exceed 25 ppmvd NOₓ and 10 ppmvd CO at 15 percent O₂, respectively. Curve 60 (upper curve) represents such achievable low power levels (turn down capability) under conventional operations, i.e., without an air extraction from the compressor per FIG. 1. That is, curve 60 illustrates the limits of low power output that are achievable when only throttling down air flow through the compressor with the inlet guide vanes.

Curve 70 (lower curve) of FIG. 2 represents the lowest achievable output power levels, for which NOₓ and CO emissions are in compliance with the same requirements set for the minimum power output levels along the curve 60 (i.e., at 15 percent O₂, the NOₓ level could not exceed 25 ppmvd (parts per million, volume dry) NOₓ and the CO level could not exceed 10 ppmvd). The minimum power output levels along the curve 70 are achievable with a combination of both throttling down air flow with the compressor inlet guide vanes and recirculation of air extracted from near the output of the compressor. The data of curve 70 is based on extraction of up to about seven percent of the compressor inlet air. Generally, depending on external parameters, e.g., ambient temperature and pressure, and system design, a variable portion of the compressor air output may be fed back through the heating unit where it is merged with fresh ambient air and fed into the compressor.

The limits placed on NOₓ and CO emission levels in the example of FIG. 2 are exemplary, while a feature of the invention is an ability to control or stabilize emission levels while reducing power output of a gas turbine. Emissions will vary depending on system design, and requirements will vary, in part, based on site specific permit requirements.

For operation with only the inlet guide vanes, the lowest achievable output power level, as indicated by the curve 60, decreases as the ambient air temperature rises, ranging between an initial minimum of about 70 percent baseload ISO power at 0° F. (−18° C.) and a maximum of about 57 percent baseload ISO power at ambient temperatures above 85° F. (29.4° C.). The sloped region 62 of curve 60, extending over temperatures between 0° F. (−18° C.) and about 85° F. (29.4° C.), represents a range of temperatures over which the minimum output power is limited by the ability to use the inlet guide vanes to throttle down the air to the compressor.

At still higher temperatures, in the region 64 of curve 60, due to material limitations of the system components, the inlet guide vanes are not used to further throttle down the power output. Consequently, the power output remains relatively constant as the ambient temperature increases beyond about 85° F. (29.4° C.). Thus in the region 64 the minimum output power is exhaust temperature limited to about 57 percent of the baseload ISO power in order to maintain a requisite flame temperature to control emission levels within the predefined limits. In this example, the power cannot be reduced below about 57 percent of the baseload ISO power.

The curve 70 represents operation with the combination of throttling down air flow with the inlet guide vanes and also feeding back a portion 34 of the air 14 from the output of the compressor 12 in accord with the system 2 of FIG. 1. The relatively flat region 72 of the curve 70 extends over temperatures between 0° F. (−18° C.) and about 60° F. (15.6° C.) representing a range of temperatures over which a minimum output power of about 50 percent of the baseload ISO power is achievable. This lower limit is turbine exhaust temperature limited. At temperatures exceeding 60° F. the turbine exhaust temperature continues to limit the range in turn down power and the extraction flow is throttled down to limit the maximum compressor inlet air temperature to 120° F.

The example of FIG. 2 illustrates that use of air extraction, according to the embodiment of FIG. 1, to maximize turn down of power while controlling emissions levels, can be most effective at relatively cold ambient temperatures. A reduction of 50 percent of the 100 percent base load ISO power output can be achieved. By recirculating about seven percent of the compressor air output back through the compressor an additional turndown of about twenty percent (relative to curve 60) is attainable at 0° F. (−18° C.), and an additional turndown of eleven percent (relative to curve 60) is attainable at 60° F. (15.6° C.). A twenty percent turndown corresponds to approximately an eleven percent reduction in fuel consumption and an eleven percent turndown corresponds to an approximately five percent reduction in fuel consumption. Also with reference to the embodiment of FIG. 1, the portion 34 of compressed air to be extracted from and recirculated through the compressor 16 is dependent on external parameters (e.g., including ambient temperature and pressure) and system design. For example, in the region 74 of the curve 70, to sustain the requisite exhaust temperature for desired emissions control, the portion of extracted air was throttled down to maintain a maximum compressor inlet air temperature of 120° F. (48.9° C.) based on compressor design limitations.

A decline in turn down capability at hotter ambient temperatures, e.g., above 60° F. (15.6° C.), is of lesser import because periods of low demand, for which compressor air extraction is of most benefit, occur overnight during periods when ambient temperatures in many climates are relatively cool.

A feature of the invention is that, while the operating characteristics of different gas turbine engines will vary, air extraction at the compressor output is a means of turning down gas turbine power while providing stability to the flame temperature. In turn, this imparts greater stability in the emissions levels in order to maintain limits for purposes of environmental compliance.

To summarize, a method of reducing power output in an electric power generation system has been described. The method may be applied to simple cycle power plants utilizing only gas turbines for power generation or to more complex systems, including combined cycle power plants, utilizing both a Brayton Cycle and a Rankine cycle. In one series of embodiments an air compressor is configured to receive ambient air at an intake section and generate pressurized air flow for output therefrom. The compressor includes a set of controllable inlet guide vanes for selectively throttling the ambient air taken into the compressor. The combustion chamber receives a combination of at least a portion of the pressurized air flow output from the compressor and fuel for combustion of the fuel therein, this resulting in an output of pressurized combustion gas or exhaust. The gas turbine section receives the pressurized combustion gas for expansion within the turbine section to generate mechanical power and a generator converts the mechanical power into electric power.

With the system operating at a steady state level of power output, e.g., at a maximum load or at one hundred percent of the baseload ISO power output, the power being output by the turbine section may be turned down by extracting a portion of the pressurized air flow generated by the compressor before entry into the combustor. The extracted portion of compressed air may be equal to at least three percent of the pressurized air flow being output from the air compressor, and may range up to or beyond 11 percent of the air flow output from the air compressor. In the disclosed embodiments, the extracted portion of air output from the compressor is recirculated through the compressor intake section for mixing with received ambient air. This recirculation may be effected with positioning of a flow line at the compressor output to selectably extract the portion of the pressurized air flow being output from the air compressor before entry into the combustor, and then inserting that portion of the air flow through the flow line and into the compressor intake section for mixing with received ambient air.

For the embodiment shown in FIG. 1, the portion 34 of air 14 is extracted from the discharge of the compressor 12. In other embodiments, the compressed air may be obtained via an interstage extraction. For example, the above-referenced model SGT6-5000F gas turbine includes multiple interstage extraction ports, any one of which could be used to recirculate compressed air through an inlet port of the compressor. Because air extracted at an early stage of the compressor would be of a lower temperature than the air at the discharge point shown in FIG. 1, an extraction at an early stage can require much more than seven or ten percent of the air produced by the compressor to achieve a comparable amount of temperature increase at the compressor inlet.

As shown in the embodiment of FIG. 1, the extracted portion of the air may be injected from the flow line into a heating unit for mixing with the ambient air prior to entry into the compressor. According to embodiments of the invention the method includes adjusting the inlet guide vanes of the compressor to facilitate throttling down pressurized air flow through the compressor while also recirculating the portion of extracted air flow into the compressor intake section for mixing with newly received ambient air. Generally, with a characteristic minimum flame temperature during steady state operation (e.g., at one hundred percent rated maximum power), and with the exhausted combustion gas limited to a predetermined volumetric percentage of NOₓ or CO: by extracting a portion of the pressurized air flow from the compressor, the characteristic minimum flame temperature can be maintained in the combustor while, at the same time, the power output can be reduced at least 45 percent relative to the steady state operation.

Embodiments of the invention are not limited to turn down from a maximum load level or from one hundred percent of the ISO rated maximum power output of the Brayton cycle. Reference to a relatively high steady state power output level means any suitable power output level (e.g., any percent of any maximum rated power output) from which a power turn down is desired.

While various embodiments of the present invention have been shown and described herein, such embodiments are provided by way of example only. Numerous variations, changes and substitutions may be made without departing from the invention herein. Accordingly, it is intended that the invention be limited only by the spirit and scope of the appended claims.

The claimed invention is:

1. A method of reducing power output in an electric power generation system comprising:
providing an air compressor configured to receive ambient air at an intake section and generate pressurized air flow for output therefrom, the compressor including a set of controllable inlet guide vanes for selectively throttling the ambient air taken into the compressor;
configuring a combustion chamber in the system to receive a combination of at least a portion of the pressurized air flow output from the compressor and fuel for combustion of the fuel therein and output of exhaust comprising pressurized combustion gas;
positioning a gas turbine section to receive the pressurized combustion gas for expansion within the turbine section to generate mechanical power;
coupling a generator to receive the mechanical power and convert the mechanical power into electric power;
operating the system at a relatively high steady state level of power output; and
turning down the power being output by the turbine section by extracting a portion of the pressurized air flow generated by the compressor before entry into the combustor, said portion equal to at least three percent of the pressurized air flow being output from the air compressor.

2. The method of claim 1 further including, after extracting, recirculating said portion of the pressurized air flow through the compressor intake section by mixing said portion with received ambient air upstream of the compressor.

3. The method of claim 2 wherein said portion of the pressurized air flow being extracted is recirculated through the compressor:
by positioning a flow line to selectably extract said portion of the pressurized air flow being output from the air compressor before entry into the combustor; and
by inserting said portion of the air flow through the flow line and into the compressor intake section for mixing with received ambient air.

4. The method of claim 3 wherein mixing with received air is effected by inserting said portion into a heating unit which also receives the ambient air upstream of the compressor.

5. The method of claim 2 further including adjusting the inlet guide vanes to throttle down pressurized air flow, relative to the relatively high steady state operation, through the compressor while inserting said portion of the air flow into the compressor intake section for mixing with received ambient air.

6. The method of claim 5 wherein:
the step of operating the system at a relatively high steady state level of power output is performed by operating the system at a percentage of one hundred percent rated maximum power of the system; and
the combination of adjusting the inlet guide vanes and inserting said portion of the air flow into the compressor intake section reduces the output power of the power generation system by at least 45 percent of the rated maximum power.

7. The method of claim 6 wherein the combination of adjusting the inlet guide vanes and inserting said portion of the air flow into the compressor intake section reduces the output power of the power generation system to at least 50 percent of the rated maximum power.

8. The method of claim 1 wherein:
the combustor has a characteristic minimum flame temperature during the relatively high steady state level of power operation for which exhausted combustion gas comprises a predetermined volumetric percentage of NOₓ or CO; and
the step of extracting said portion of the pressurized air flow to turn down the power being output by the turbine section includes maintaining flame temperature to be no less than the characteristic minimum flame temperature in the combustor when the power being output is reduced at least 45 percent relative to the relatively high steady state level of power operation output of the system.

9. The method of claim 8 wherein the step of extracting said portion of the pressurized air flow to turn down the power being output by the turbine section includes maintaining flame temperature to be no less than the characteristic minimum flame temperature in the combustor when the power being output is reduced at least 50 percent relative to the one hundred percent rated maximum power output of the system.

10. The method of claim 8 wherein, with the power turned down while maintaining the flame temperature to be no less than the characteristic minimum flame temperature in the combustor, the exhausted combustion gas comprises a volumetric percentage of NOₓ or CO which does not exceed the predetermined volumetric percentage corresponding to the relatively high steady state level of power operation output of the system.

11. The method of claim 1 wherein the step of operating the system at a relatively high steady state level is at a maximum power output of the gas turbine.

12. The method of claim 1 wherein the step of operating the system at a relatively high steady state level is at a defined one hundred percent maximum baseload ISO power.

13. The method of claim 1 wherein the gas turbine section is coupled to provide gas received from the combustor to a HRSG for transfer of sensible heat into a Rankine cycle.

14. The method of claim 8 wherein the relatively high steady state operation is at one hundred percent of the baseload ISO power output.

15. A method of operating an electric power generation system comprising:
configuring an air compressor to generate pressurized air flow for output therefrom, the compressor including a set of controllable inlet guide vanes for selectively throttling the air flow output from the compressor;
receiving into a combustion chamber a combination of at least a portion of the pressurized air flow output from the compressor and fuel for combustion therein and output of exhaust comprising pressurized combustion gas;
receiving into a gas turbine section the pressurized combustion gas for expansion to generate mechanical power;
transferring the mechanical power to a generator to generate electric power,
wherein the foregoing steps are performed to operate the system at a relatively high steady state level of power output, the method further including turning the power output down by extracting a portion of the pressurized air flow generated by the compressor before entry into the combustor and recirculating said portion through the compressor, said portion equal to at least three percent of the pressurized air flow being output from the air compressor.

16. The method of claim 15 further including adjusting the inlet guide vanes to throttle down pressurized air flow, relative to the relatively high steady state operation, through the compressor while inserting said portion of the air flow into the compressor intake section for mixing with received ambient air.

17. The method of claim 15 further including providing combustion gas received by the gas turbine to a HRSG for transfer of sensible heat into a Rankine cycle.

18. The method of claim 15 wherein the step of operating the system at a relatively high steady state level is at a maximum power output of the gas turbine.

19. The method of claim 15 wherein:
the combustor has a characteristic minimum flame temperature during the relatively high steady state operation for which the combustion gas comprises a predetermined volumetric percentage of NOₓ or CO; and
the step of turning down the power maintains the characteristic minimum flame temperature in the combustor when the power being output is reduced at least 45 percent relative to power output at the relatively high steady state operation or relative to one hundred percent rated maximum power output of the system.

20. The method of claim 19 wherein, with the power turned down while maintaining the characteristic minimum flame temperature in the combustor, the combustion gas comprises a volumetric percentage of NOₓ or CO which does not exceed the predetermined volumetric percentage corresponding to the relatively high steady state operation.
